(19) United States
(12) Patent Application Publication
(10) Pub. No.: US 2012/0024640 A1
(43) Pub. Date: Feb. 2, 2012

(54) ENERGY ABSORBING DEVICE FOR ANCHORING A LIFELINE OR THE LIKE

(76) Inventor: Rodolphe ARGOUD, Laval (FR)

(21) Appl. No.: 13/189,618

(22) Filed: Jul. 25, 2011

(30) Foreign Application Priority Data
Jul. 29, 2010 (FR) 10/56242

(51) Int. Cl. A62B 35/04

(52) U.S. Cl. 188/65.2

(57) ABSTRACT

An energy absorbing device including a casing, fastening means for fastening the casing to a fixed point, a first cable portion wound inside the casing, connection means attached to the first cable portion and designed to be connected to a lifeline, a friction ring mounted on the first cable portion so as to exert a clamping force on the latter, and stop means against which the friction ring is designed to bear, where the clamping force exerted by the friction ring on the first cable portion is predetermined so as to allow a relative displacement of the first cable portion in relation to the friction ring when the friction ring is bearing against the stop means and when a traction force above a predetermined value is exerted on the connection means.

### TECHNICAL FIELD

The present invention relates to an energy absorbing device for anchoring a lifeline or the like.

### BACKGROUND

The device in question concerns the field of safety against falls for persons working at height, in particular on roofs of buildings or other structures.

To ensure the safety of a person, the latter is equipped with a harness which is designed to be fastened to an anchoring point or to a lifeline via a karabiner. In the event of a fall, it is the anchoring point, which is fastened for example to a wall, to a frame or to a roof, that catches the person as he falls. The lifeline may consist for example of a cable or of straps. Lifelines which are fastened at their ends to structures transmit forces, which may be very high, to the fastening zones on the structures. These forces depend on various parameters, such as the composition and length of the lifeline, the spacing of the intermediate and corner check points, and the number of persons connected simultaneously.

However, the structure to which the lifeline is fastened does not always have sufficient strength to withstand high forces, as is the case for example during the fall of a person. In such cases, therefore, it is advisable that the device for anchoring the lifeline has an energy absorbing capability, functioning in the manner of a shock absorber.

Some known shock absorbers comprise damping means which use the compression or traction of elastic components, in particular springs. Such shock absorbers are usually for single use and deform, including when low amounts of strain are exerted thereon.

The document EP 2 095 847 describes an energy absorbing device comprising a cylindrical housing provided with means for fastening to a fixed point, a piston which can be displaced axially inside the cylindrical housing, a rod which has one end attached to the piston and the other end projecting outside the housing and which is provided with means for connection to a lifeline, and a damping element accommodated in the cylindrical housing and designed to be compressed by the piston. In the event of a fall of an operator connected to a lifeline provided with such an energy absorbing device, a traction force is exerted on the connection means, and thus on the rod, which causes a displacement of the piston and a compression of the damping element. This results in absorption of some of the energy brought about by the falling of the operator.

This type of energy absorbing device uses the travel of a piston inside a cylindrical housing to absorb shocks. Thus, to obtain satisfactory energy absorption, it is necessary to provide a sizeable device in order to ensure a satisfactory travel of such a piston.

### BRIEF SUMMARY

The present invention aims to remedy these disadvantages.

The technical problem on which the invention is based is therefore that of providing an energy absorbing device which is of simple structure, economic and of small size, which does not deform below a certain strain threshold, and which is safe to use.

To this end, the present invention relates to an energy absorbing device for anchoring a lifeline or the like, characterised in that it comprises:
a casing,
fastening means for fastening the casing to a fixed point,
a first cable portion wound inside the casing,
connection means attached to the first cable portion and designed to be connected to a lifeline,
a friction ring mounted on the first cable portion so as to exert a clamping force on the latter, and
stop means arranged in the casing along a part of the first cable portion extending between the connection means and the friction ring, and against which the friction ring is designed to bear,

and in that the clamping force exerted by the friction ring on the first cable portion is predetermined so as to allow a relative displacement of the first cable portion in relation to the friction ring when the friction ring is bearing against the stop means and when a traction force above a predetermined value is exerted on the connection means.

In the event of a fall of an operator connected to a lifeline equipped with an energy absorbing device according to the invention, a high traction force is exerted on the connection means, which brings about a relative displacement of the first cable portion in relation to the friction ring, and more particularly a sliding of the first cable portion inside the latter. The friction brought about by such a displacement of the first cable portion absorbs at least in part the energy due to the shock.

Under normal use conditions, the operator connected to the lifeline exerts a low traction force on the connection means, which prevents any relative movement between the first cable portion and the friction ring.

Thus the energy absorbing device according to the invention therefore does not deform below a certain strain threshold, which avoids any untimely triggering of the energy absorbing device.

Furthermore, the use of a cable portion would inside a casing with a view to absorbing the energy of a shock makes it possible to obtain a considerable absorption travel while maintaining a device of small size.

Moreover, the obtaining of a considerable absorption travel makes it possible to improve the safety of use of the energy absorbing device according to the invention.

Advantageously, the energy absorbing device comprises a second cable portion comprising a first end connected to the fastening means and a second end connected to the connection means. These provisions make it possible to ensure that an operator is caught in the event of breakage of the first cable portion, and thus further to improve the safety of use of the energy absorbing device.

Preferably, the first and second cable portions and the connection means are formed by one and the same cable.

Advantageously, the first cable portion comprises a free end opposite the connection means and comprising an end-of-travel stop designed to cooperate with the friction ring.

Preferably, the stop means comprise a stop ring having a through-opening, through which the first cable portion extends.

According to one embodiment of the invention, the energy absorbing device comprises two plates spaced apart from one another and each having at least a first portion arranged inside the casing and a second portion projecting outside the casing, the stop means being attached to the first portions of said plates, and the second portions of said plates forming at least in part the fastening means.

Preferably, the fastening means additionally comprise a fastening pin designed to be engaged and locked into eyelets formed in the second portions of said plates.

Advantageously, the fastening means are mounted such as to be able to move relative to the casing between a first position, referred to as the retracted position, in which the fastening means are located close to the casing, and a second position, referred to as the extended position, in which the fastening means are moved away from the casing, the fastening means being designed to be displaced into the second position when a traction force above a predetermined value is exerted on the connection means, and the energy absorbing device comprises at least one visual strain indicator, advantageously of bright colour, which is designed to be visible from outside the casing when the fastening means are in the second position. These provisions make it possible to visualise in a sure and indisputable manner any strain on the device according to the invention.

According to one embodiment of the invention, the first end of the second cable portion is connected to the fastening means via a clevis mounted in a pivoting manner on the fastening means.

Preferably, the friction ring is mounted by crimping on the first cable portion.

### BRIEF DESCRIPTION OF THE DRAWINGS

In any event, the invention will be clearly understood with the aid of the following description with reference to the appended schematic drawing which shows, by way of non-limiting example, one embodiment of this energy absorbing device.

FIG. 1 is a perspective view of an energy absorbing device according to the invention.

FIG. 2 is a perspective view of the energy absorbing device of FIG. 1 after a strain on the connection means.

FIG. 3 is an exploded view of the energy absorbing device of FIG. 1.

FIG. 4a is a partial perspective view of the energy absorbing device of FIG. 1.

FIG. 4b is an enlarged view of a detail of FIG. 4a.

FIG. 5a is a sectional view along the line V-V of FIG. 4a.

FIG. 5b is an enlarged view of a detail of FIG. 5a.

FIGS. 6 and 7 are partial views of the energy absorbing device of FIG. 1, showing said device in two different strain positions.

FIG. 8 is a side view of a lifeline equipped with an energy absorbing device according to FIG. 1, under normal use conditions.

FIG. 9 is a side view of a lifeline equipped with an energy absorbing device according to FIG. 1, after a fall of an operator connected to the lifeline.

FIGS. 10 and 11 are side views of an energy absorbing device according to one variant embodiment of the invention, respectively showing said device before and after a strain on the connection means.

### DETAILED DESCRIPTION

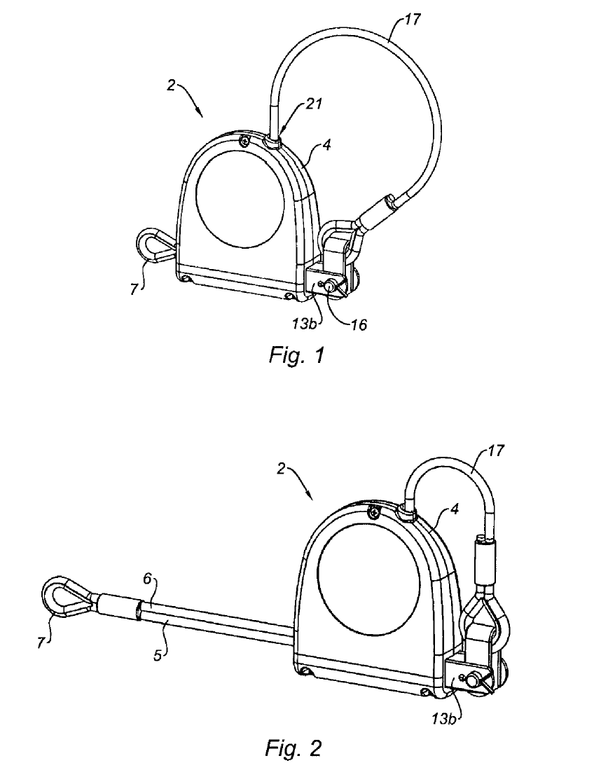

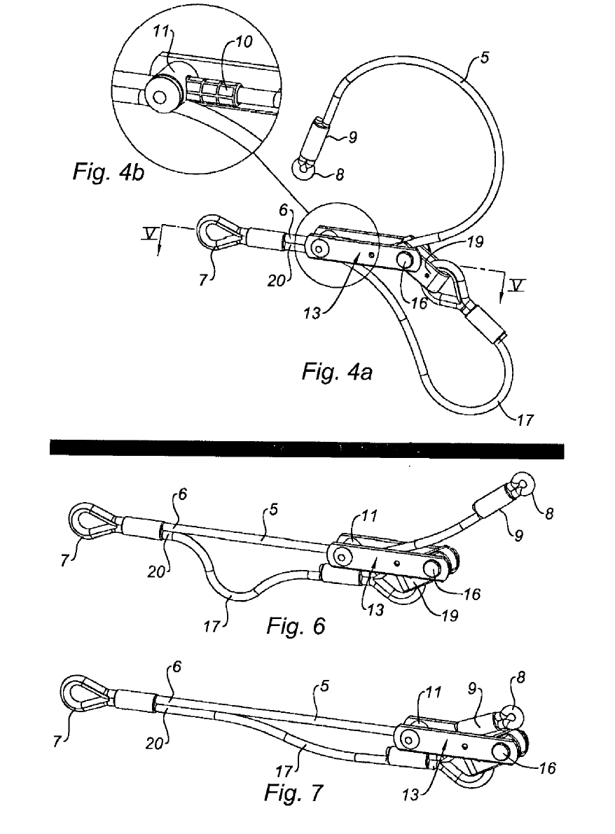

FIGS. 1 to 7 show an energy absorbing device 2 for anchoring a lifeline.

The energy absorbing device 2 comprises a casing 4 advantageously formed of two half-shells which are made for example from a synthetic material.

The energy absorbing device 2 furthermore comprises a first cable portion 5 wound inside the casing 4. The first cable portion 5 comprises a first end 6 attached to connection means 7 projecting outside the casing and designed to be connected to a lifeline, and a free second end 8, opposite the connection means 7, equipped with an end-of-travel stop 9.

The energy absorbing device 2 also comprises a friction ring 10 mounted by crimping on the first cable portion 5 so as to exert a clamping force on the latter.

The clamping force exerted by the friction ring 10 on the first cable portion 5 is predetermined so as to allow a relative displacement of the first cable portion 5 in relation to the friction ring 10 when a traction force above a predetermined value is exerted on the connection means 7. The predetermined value is for example equal to approximately 4.5 kN.

The energy absorbing device 2 moreover comprises a stop ring 11 having a through-opening 12, through which the first cable portion 5 extends. The stop ring 11 is arranged in the casing 4 along a part of the first cable portion 5 extending between the connection means 7 and the friction ring 10. As shown in FIG. 5b, the end of the friction ring 10 facing towards the connection means 7 bears against the stop ring 11, and more particularly against a shoulder surrounding the through-opening 12. The stop ring 11 advantageously extends substantially perpendicular to the friction ring 10.

The energy absorbing device 2 comprises two rigid plates 13, which are preferably made of metal and are substantially identical and parallel. The two plates 13 are spaced apart from one another and each have a mounting portion 13a arranged inside the casing 4 and a fastening portion 13b projecting outside the casing 4.

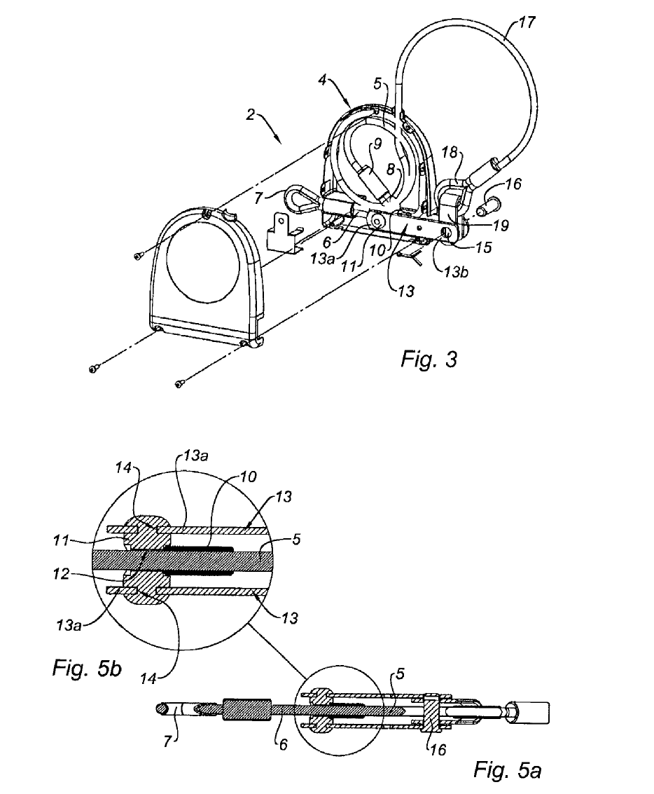

As shown in FIG. 5b, the mounting portions 13a each comprise an eyelet 14 allowing the crimping of the end portions of the stop ring 11. As shown in particular in FIG. 3, the fastening portions 13b each comprise an eyelet 15 in which a fastening pin 16 is designed to be engaged and locked so as to allow a fastening of the casing 4 to a fixed point.

The energy absorbing device 2 additionally comprises a second cable portion 17 comprising a first end 18 connected to the plates 13 via a clevis 19 mounted in a manner pivoting about the fastening pin 16, and a second end 20 connected to the connection means 7. The second cable portion 17 comprises a first part extending inside the casing 4 and a second part extending outside the casing 4, the second part projecting outside the casing through an opening 21 delimited by the latter.

The first and second cable portions 5, 17 may each be formed from a single-strand or multi-strand cable, for example made from stainless steel.

The first and second cable portions 5, 17 and the connection means 7 are advantageously formed by one and the same cable folded onto itself so as to form a connection loop 7 forming the connection means, and two cable portions forming the first and second cable portions 5, 17.

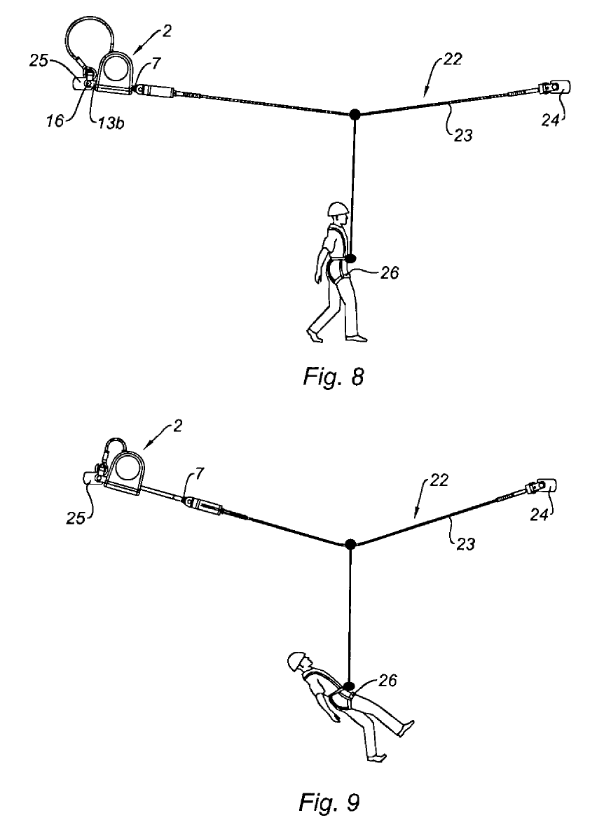

FIG. 8 shows a lifeline 22 equipped with the energy absorbing device 2. The lifeline 22 comprises a cable 23, one of the ends of which is connected to the connection means 7 of the energy absorbing device 2 via a tensioner, and the other end of which is fastened to a fixed point 24. It should be noted that the fastening portions 13b and the fastening pin 16 fasten the energy absorbing device 2 to a fixed point 25.

Under normal use conditions, an operator 26 connected to the lifeline 22 exerts a low traction on the cable 23 of the lifeline 22. Consequently, the traction force exerted on the connection means 7 is low in comparison to the clamping force exerted by the friction ring 10 on the first cable portion 5 and does not allow a relative displacement between the first cable portion 5 and the friction ring 10. This makes it possible to prevent any untimely triggering of the energy absorbing device 2.

In the event of an accidental fall of the operator 26 connected to the lifeline (see FIG. 9), said operator gives rise to a high traction force on the cable 23 of the lifeline and, consequently, on the connection means 7. This high traction force is greater than the clamping force exerted by the friction ring 10 on the first cable portion 5 and therefore allows a displacement of the first cable portion 5 inside the friction ring 10. This results in the connection means 7 moving away from the casing 4, as shown in particular in FIGS. 6 and 9.

During this displacement of the first cable portion 5, the outer wall of the latter is displaced by rubbing along the inner wall of the friction ring 10, which produces an energy absorption and therefore makes it possible to absorb at least in part the energy brought about by the falling of the operator.

It should be noted that the displacement of the first cable portion 5 is likely to continue until the end-of-travel stop 9 mounted at the second end 8 of the first cable portion 5 comes to bear against the friction ring 10 (see FIG. 7).

It is clear in particular from FIG. 9 that an operator can see immediately that the device 2 has been subjected to a shock and has dampened a shock, in view of the extent to which the connection means 7 have moved away from the casing 4.

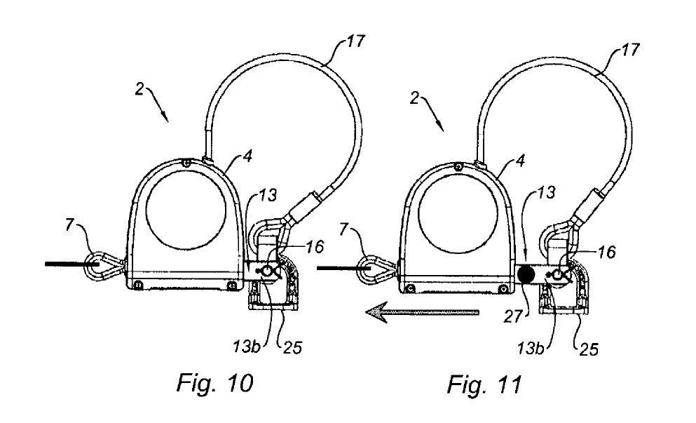

According to a variant embodiment of the invention, shown in FIGS. 10 and 11, the plates 13 are mounted such as to be able to move relative to the casing 4 between a first position, referred to as the retracted position, in which the fastening portions 13b are located close to the casing (see FIG. 10), and a second position, referred to as the extended position, in which the fastening portions 13b are moved away from the casing (see FIG. 11), the plates 13 being designed to be displaced into the second position when a traction force above a predetermined value is exerted on the connection means 7. In this variant embodiment, the energy absorbing device 2 comprises at least one visual strain indicator 27, advantageously of bright colour, which is formed on one of the plates 13 and is designed to be visible from outside the casing 4 when the fastening portions 13b are in the second position.

As will be understood, the invention is not limited to the only embodiment of this energy absorbing device described above by way of example, but rather encompasses all variant embodiments thereof.

1. Energy absorbing device for anchoring a lifeline or the like, comprising:
a casing,
fastening means for fastening the casing to a fixed point,
a first cable portion wound inside the casing,
connection means attached to the first cable portion and designed to be connected to a lifeline,
a friction ring mounted on the first cable portion so as to exert a clamping force on the latter, and
stop means arranged in the casing along a part of the first cable portion extending between the connection means and the friction ring, and against which the friction ring is designed to bear,
wherein the clamping force exerted by the friction ring on the first cable portion is predetermined so as to allow a relative displacement of the first cable portion in relation to the friction ring when the friction ring is bearing against the stop means and when a traction force above a predetermined value is exerted on the connection means.

2. Energy absorbing device according to claim 1, further comprising a second cable portion comprising a first end connected to the fastening means and a second end connected to the connection means.

3. Energy absorbing device according to claim 2, wherein the first and second cable portions and the connection means are formed by one and the same cable.

4. Energy absorbing device according to claim 1, wherein the first cable portion comprises a free end opposite the connection means and comprising an end-of-travel stop designed to cooperate with the friction ring.

5. Energy absorbing device according to claim 1, wherein the stop means comprise a stop ring having a through-opening, through which the first cable portion extends.

6. Energy absorbing device according to claim 1, further comprising two plates spaced apart from one another and each having at least a first portion arranged inside the casing and a second portion projecting outside the casing, the stop means being attached to the first portions of said plates, and the second portions of said plates forming at least in part the fastening means.

7. Energy absorbing device according to claim 6, wherein the fastening means comprise a fastening pin designed to be engaged and locked into eyelets formed in the second portions of said plates.

8. Energy absorbing device according to claim 1, wherein the fastening means are mounted such as to be able to move relative to the casing between a first position, referred to as a retracted position, in which the fastening means are located close to the casing, and a second position, referred to as an extended position, in which the fastening means are moved away from the casing, the fastening means being designed to be displaced into the second position when a traction force above a predetermined value is exerted on the connection means, and wherein the energy absorbing device comprises at least one visual strain indicator, advantageously of bright colour, which is designed to be visible from outside the casing when the fastening means are in the second position.

9. Energy absorbing device according to claim 2, wherein the first end of the second cable portion is connected to the fastening means via a clevis mounted in a pivoting manner on the fastening means.

10. Energy absorbing device according to claim 1, wherein the friction ring is mounted by crimping on the first cable portion.
